(19) United States
(12) Patent Application Publication
(10) Pub. No.: US 2009/0012999 A1
(43) Pub. Date: Jan. 8, 2009

(54) Pushing a targeted audience to a particular location

(75) Inventor: William Sweeney, Weare, NH (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: Danconia Media

(21) Appl. No.: 11/825,217

(22) Filed: Jul. 3, 2007

(51) Int. Cl. G06F 7/00

(52) U.S. Cl. 707/104.1

(57) ABSTRACT

A method for pushing a targeted audience to a specific location includes identifying an entity having a connection to the targeted audience and agreeing to enter into a Targeted Audience Initiator arrangement with the entity. The entity is then providing with materials for pushing members of the targeted audience to the specific location. The entity is then compensated in exchange for pushing members of the targeted audience to the specific location.

### BACKGROUND OF THE INVENTION

This invention relates generally to driving a targeted audience to a specific location-either physical or digital-and more particularly to initiating targeted Internet traffic using a “push” process.

Currently traffic driven to online locations is a process of happenstance. Online users' or viewers' entrance points to the Internet is generally done through one of the major search engines in an attempt to locate a subset of information of particular interest to the viewer. A group or person(s) interested in gaining a targeted viewer to their subset of information (e.g., a vendor) currently does so in several ways, all using a one-to-one relationship. That is, a relationship where a vendor advertises to gain the eyes of a single viewer based on a search. Such techniques, each of which is generally known as a passive pull architecture, include:
a. advertising in local print media in an attempt to get the print media viewer to take a desired action, one to look at the vendor's information online;
b. building an online content presence in the form of a web site and rely on the Internet search engines to index their location pertaining to the information subset they are looking to target; and
c. using pay per target advertising that would include pay per click, pay per call, and pay per view methods which are presented within the search engine results container, i.e., a search results page.

There are many drawbacks to the current processes for directing targeted traffic to a desired vendor location. In general terms, there is no control over the entrance point of viewers to date. Major search engines like Google and Ask Jeeves, as well as broad global directories such as Yahoo, offer a limited entrance point for consumers to the Internet. These pages are often “bookmarked” by users of browsers like Internet Explorer, Firefox, and Netscape. This becomes the default location of the users entrance to the World Wide Web. These locations are of the broadest in kind, and offer no targeted point of entry for a vendor to attract the attention of the consumer base towards a specific subset of information. In these cases, the above-mentioned points of entry are too broad and global in nature to be targeted effectively. A viewer must first log on to the desired search mount point and then type in a string of text and numerals to locate a broad base of information. Unless a search result is paid for, the chance any vendor's information is seen is remote at best. The first mentioned technique of paying for advertising is limited because the cost per client can be extremely high. The chances of getting a viewer at the precise time they are looking for a product and service to take an action of accessing the Internet is highly remote and not controlled by the vendor.

The option of using pay per target advertising noted above also has drawbacks. Current models are troubled with fraudulent clicks, views, and calls. This drives up the cost of the audience, allows competitors to affect the likelihood of success, and completely undermines the model. The cost of these models can be enormous and becomes cost prohibitive for all but the largest national and global providers of services and products. There may be a cap against cost escalation pre-determined by the vendor, but once that threshold has been reached their “campaigns” are halted and they no longer get any exposure. Current tactics utilizing click fraud techniques are being implemented explicitly to reduce competition of competitors in many high impact fields that optimize for online market share manipulation. In doing so they reduce their own overall cost by eliminating any alternative options early on in campaigns.

The current processes discussed above are broad based national or global solutions without any interaction with either the vendors or the viewership other than what is done through the online presence. So the targeted audience will be broad in scope as well, reducing the likelihood of success with what is known as the conversion rate. There is no connection in like between the vendor and the audience at the point of inception.

Accordingly, it would be desirable to have a process for driving targeted audiences to online or other locations that overcomes the drawbacks of current methods.

### SUMMARY OF THE INVENTION

The above-mentioned need is met by the present invention, one embodiment of which includes a method of pushing a targeted audience to a specific location, which includes identifying an entity having a connection to the targeted audience and agreeing to enter into a Targeted Audience Initiator arrangement with the entity. The entity is then providing with means for pushing members of the targeted audience to the specific location. The entity is then compensated in exchange for pushing members of the targeted audience to the specific location.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 graphically illustrates a Targeted Audience Initiator (TAI) arrangement.

FIG. 2 is a flow chart depicting a method for implementing and conducting a TAI arrangement.

### DETAILED DESCRIPTION OF THE INVENTION

The present invention relates to methods and systems for driving a targeted audience to a particular location—either physical or digital—via a push technology referred to herein as the Targeted Audience Initiator (TAI). The TAI may be used to increase the volume of traffic, as well as the quality of the traffic, across any designated location that provides data in the form of alphanumeric text, graphics, video, and/or audio information. These locations can be in the form of a world wide web URL address (i.e., a web address and web site), an online FTP location (i.e., file transfer protocol location), an engineered web portal (i.e., web site for groups of similar information), or a physical location in the form of a business, residence, gathering place, or the like. The TAI allows for an accelerated targeted group of viewers to be “pushed” to the above-mentioned location through a process designed with sociological consumer behavior patterns implemented.

Once this technology is implemented into a business model, it produces a benefit to its initiator by driving a targeted subset of an audience to the desired location. As this location is a “referred” location, the value of the information contained therein adopts a higher value to the viewers and becomes more reliable, legitimate, and desirable as usable information. This will promote an increase in the use and reference of the information contained within the location.

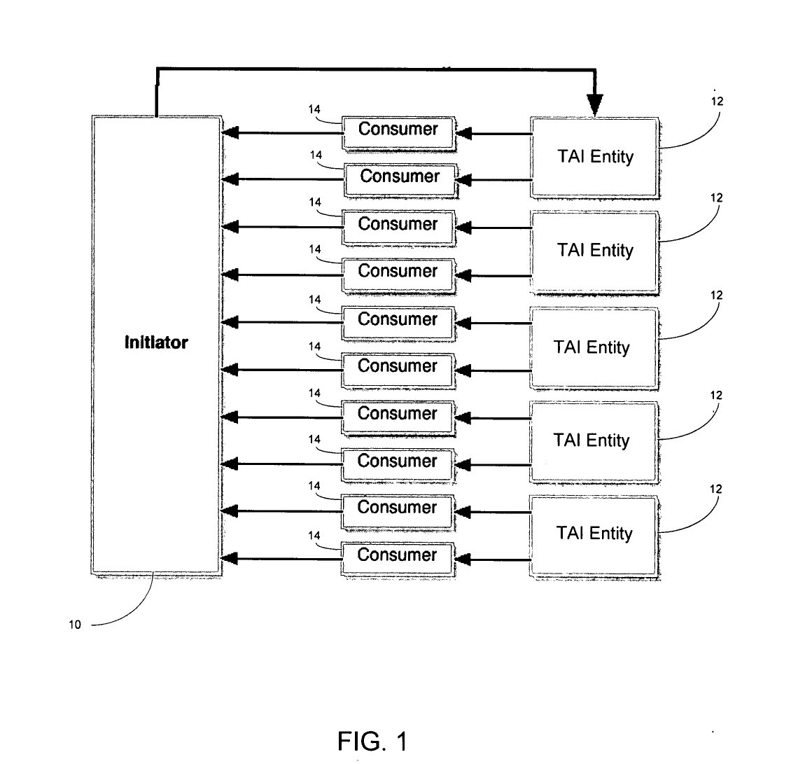

Referring to FIG. 1, one possible TAI arrangement is depicted schematically. An organization 10 (referred to herein as an “Initiator”) that operates a particular location desires to push a targeted audience to the particular location using TAI technology. The Initiator 10 approaches one or more entities 12 (referred to herein as “TAI Entities”) that have some connection to members of the targeted audience. The Initiator 10 solicits or induces the TAI Entities 12 to promote traffic to the above-mentioned location. Each TAI Entity 12 motivates certain members of the targeted audience 14 (referred to herein as an “Consumers”) to visit the location. In return the TAI Entity 12 receives a reward benefit from the Initiator 10 based on the performance of its generated traffic. The reward benefit could be in the form of a per target audience unit price, or in the form of a percentage of a contributed whole by an entity.

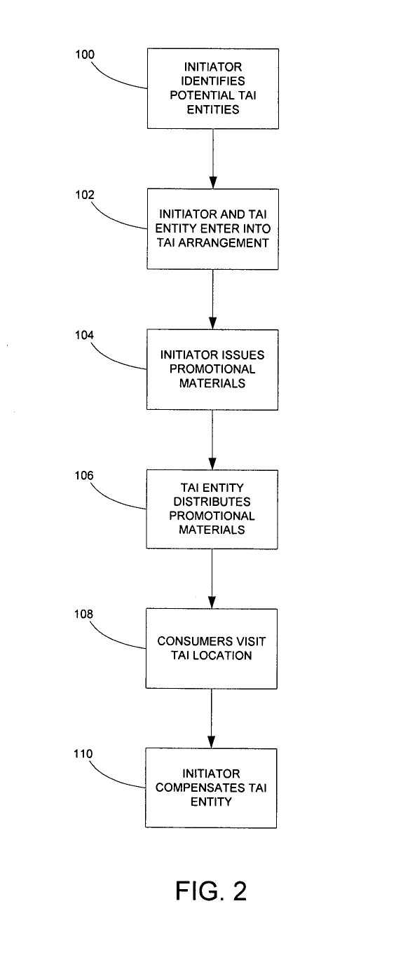

FIG. 2 depicts the basic flow of implementing and conducting a TAI arrangement. To initiate a TAI sponsored campaign, the Initiator 10 first identifies one or more entities to function as TAI Entities 12, at block 100. Such entities can include, but are not limited to, educational institutions, non-profit organizations, charities, home based businesses, special interest groups and individuals. The Initiator 10 will research each potential entity to assess their suitability for functioning as a TAI Entity.

Next, at block 102, the Initiator 10 enters into a TAI arrangement with one or more TAI Entities 12. The Initiator 10 will approach the entity or entities deemed suitable for serving as TAI Entities 12 and propose entering into a TAI arrangement. The proposal will set forth the terms under which the TAI arrangement will operate. These terms will typically include a compensation scheme and the provisioning of co-branded sales materials. When an entity agrees to the terms set forth, it becomes an authorized TAI Entity 12. The TAI authorization can be open ended or have a limit to a particular campaign.

Each TAI Entity 12 will then be issued co-branded themed promotional materials to promote the TAI campaign, at block 104. These materials will be co-branded with the identity of the Initiator 10 and the TAI Entity 12. Promotional materials may comprise print and/or digital media such as posters, postcards, business cards, brochures, e-mail cards, and magazines. The promotional materials will identify how to access the particular location (such as listing an entrance point to the World Wide Web in the form of a URL) and provide an entity ID number that will allow Consumers 14 visiting the location to notify the Initiator 10 they have accessed the location and were directed there by the particular TAI Entity 12.

Next, at block 106, the TAI Entity 12 distributes the co-branded promotional materials to various Consumers 14. The promotional materials can be distributed physically in the case of posters, postcards, business cards, brochures, magazines, etc., or digitally in the form of electronic postcards, brochures and the like. The TAI Entity 12 can utilize a “sales force” to market the TAI to Consumers 14. The sales force can use a variety of marketing techniques including door-to-door sales, the use of brochure stands, e-mail campaigns, or other sales techniques.

The TAI Entity 12 typically distributes the promotional materials to Consumers 12 that are connected to, or have an interest in supporting, the TAI Entity 12. For instance, if the TAI Entity 12 were an educational institution, it would tend to distribute promotional materials to individuals having a connection to the institution, such as students, parents of students, alumni, and other supporters. Other types of TAI Entities might attract Consumers 12 having some other commonality, which could even be geographic. The TAI thus functions to push a particular demographic population to the location, therefore allowing the Initiator 10 to access a targeted audience.

Some or all of the Consumers 14 receiving the promotional materials will visit the location identified on the promotional materials, at block 108. Because the Consumers 14 generally have an interest in supporting the TAI Entity 12 that provided them with the promotional materials, they will be motivated to actually visit the identified location in order to provide the TAI Entity 12 with the reward benefit provided by the Initiator 10. The Consumer's desire to support the TAI Entity 12 would be their incentive to actually visit the identified location. This is how the TAI functions to “push” Consumers 14 to the designated location. By way of example, say a TAI Entity is a booster club working to raise funds for a high school football team. This TAI Entity would generally distribute the promotional materials to Consumers 12 interested in supporting the football team. Therefore, most or all of the Consumers 14 receiving the promotional materials would visit the Initiator's location to help raise funds for the team.

In one embodiment, the Consumers 14 will access the location by logging in through a portal having a dynamic web form. The TAI web form may ask participating Consumers 14 to submit certain information such as: Entity ID number, name, address, and e-mail address. The TAI web form may also offer the participating Consumers 14 an opportunity to request various pieces of information including business brochures, coupons, and specialty flyers. The TAI web form can be dynamically created to brand the TAI Entity 12 using the TAI as a fundraiser and/or it can be used to brand the Initiator 10 in a local market.

After Consumers 14 submit information, their views and information are transferred to a database. Information provided by the Consumers 14 is sorted and stored in the database for future use, and any Consumer requests for information are processed with the requested materials being sent to the Consumers 14. Consumers 14 brought to the TAI portal may also be redirected to another portal or website. In this way Consumer views flow into another portal that in turn receives page views. Consumer logins to the TAI portal are recorded and calculated using a computer program or other means. Each time a Consumers 14 logs in, that login is noted in the database for calculation of the TAI benefit that will be awarded to the TAI Entity 12. This benefit represents the fundraising value the TAI produces for the fundraising group.

Next, at block 110, the Initiator compensates the TAI Entity 12 based on the number of Consumer logins that TAI Entity 12 generates. The compensation or benefit can be calculated in any number of ways. Generally, the compensation scheme is decided upon by the Initiator 10 and the TAI Entity 12 as part of the process of setting up the TAI campaign. Possible compensation schedules include, but are not limited to, any one of the following: the TAI Entity 12 receives an upfront prize or current cash value, the TAI Entity 12 receives a predetermined amount of compensation per Consumer login, or the TAI Entity 12 receives a percentage of a total compensation pool based upon the number of Consumer logins the TAI Entity 12 generates. In the latter case, the compensation or benefit can be calculated by determining the percentage of Consumer logins generated by a particular TAI Entity 12 versus the total number of Consumer logins during a specified time limit. The amount of the benefit will be calculated by multiplying this percentage by a value that will be set prior to the campaign with a low end limit, and a high end value based on the Initiator 10 amount, or percentage, of a benefit they in turn receive from their constituency. This benefit can be in the form of a cash value benefit, or in the form of other reward such as gift certificates, coupons, or prizes.

If the benefit is in the form of a percentage of the Initiator's 10 in turn benefit, the more the Initiator 10 sees for traffic (i.e., the larger the in turn benefit), the larger the total compensation pool to be divided between the TAI Entities 12 will be. Thus, the more Consumer logins the TAI Entities 12 collectively generate, the larger the compensation will be for each TAI Entity for a given percentage. This creates a benefit circle that continues to grow with the addition of more TAI Entities 12.

The TAI technology is particularly useful for groups interested in fundraising. For example, a TAI is an ideal way for educational institutions to raise funds as opposed to traditional school fundraising processes. The current processes typically rely on school groups selling of obligatory items. With a TAI, there are no items to sell, and the amount of time it takes Consumers to login in is seconds. Any supporter of the TAI Entity will have a minimal impact on their time to push the benefit to the TAI Entity, and it will cost them nothing in terms of monetary contribution. The TAI Entity will also spend nothing to undertake the promotion of their group or organization. Furthermore, the campaign can be open ended for residual benefit unlike current school fundraising drives. The login becomes the new mount point for the entrance to the World Wide Web. This is a benefit to the Initiator; they have created a new “close” mount point for a targeted referred Consumer. Referred viewers are more likely to be receptive to new information than non-referred viewers. With an unlimited number of logins allowed, an unprecedented increase in targeted traffic can be obtained with a definitive associated cost in advance.

Non-profit organizations represent another type of organization that is well suited to a TAI arrangement. Non-profit organizations of all types struggle to garner the funds needed to support their interests. Currently, non-profit organizations rely mostly on philanthropic donations that must be requested repeatedly over time. They may also rely on the sale and promotion of obligatory item and service purchases. The success of this process is largely tied to the state of the local and national economy. A TAI for a non-profit organization utilizes the network of supporters to a genealogical local non-profit organizations to boost targeted traffic to a particular mount point to the World Wide Web. In return the non-profit organization realizes a TAI benefit to assist in funding their operation. Again, the TAI program requires no selling of products and services, but rather the mere participation of supporters to visit the TAI location and log in. This login process takes only a few seconds and costs the supporter nothing in terms of monetary contribution; the Initiator absorbs this cost.

Another ideal entity for a TAI program is a home-based business. Entrepreneurs represent an ever growing segment of the business community. These people are innovative and have a special interest in their economic well being. The TAI is an excellent solution for those small business owners to generate passive recurring revenue streams.

Special interest groups represent a demographic that is often overlooked in market targeting. Their needs are often different in nature than typical commercial enterprises. Special interest groups are comprised of subsets of societal groups that have a common interest or goal. These groups could be economic, political, or social in nature. Their motivation is not often financial or economic in nature, but in the interest of the spread of their ideals throughout a targeted demographic. A TAI program for a special interest group would be designed to target groups of potential, and current, supporters of a special interest subset. The process allows for a TAI presence to present their point of view materials (POV-M) on a co-branded “gateway” page within the Initiator's point of presence, as their online representation of their group. A special interest group TAI would get all of the co-branded promotional materials from the Initiator that would contain their general information as well as a guiding URL to their POV-M online location. When the targeted audience logs into the URL as presented on the promotional materials, a benefit is derived that can be in the form of economic reward to the special interest group TAI they have supported, or it can be in the form of work performed by the TAI Initiator on the special interest group's behalf to create ongoing materials and host them within the TAI location to further their cause.

The use of co-branded index pages may be used in conjunction with any type of TAI Entity. These index pages become the default landing page for members or supporters of the TAI Entity and circumvent traditional mount points embedded within the Internet browsers on consumer computers. The built in incentive for the creation of this mount point for the Consumer lies in the ability for their TAI Entity to obtain a benefit for the number of views the index page gets as a percentage of the total number of hits amongst all TAI Entity views. In essence, the TAI Entity's index page becomes personalized and about the TAI Entity. This further drives the allegiance from the group towards the Initiator and increases the amount of traffic to the index page. It will provide the Initiator the ability to secure the Internet mount point for that Entity's viewership as their support of book marking that page creates an automatic “hit” which increases their TAI Entity's percentage of viewers as a percentage of the whole, in turn giving their TAI Entity a greater return.

Embodiments of the current invention provide several features and benefits. Targeting a specific subset of a demographic audience allows for the making of a co-branded location for the purpose of sharing a common subset of information, or need, based on that demographic audience. This spread of information, and the addition of a benefit or reward for that subset, provides motivational factors that drive an audience to the TAI location.

Another feature is to provide for the spread of information throughout a subset of a demographic audience to the extent that it expands coverage much more deeply than with traditional methods. Because this information is pushed throughout a subset, via a member of the subset community, it automatically has a greater degree of value and importance. This will allow the information to enable the audience into the act of engaging in the taking of a desired action on the behalf of the Initiator 10. This action is also in the best interest of the audience and creates a mutually beneficial arrangement on the behalf of both parties. This further drives a larger volume of traffic to the TAI location as the benefits increase in regards to both parties. This feature will allow for the saturation of the target information to reach its deepest penetration and density as the information spreads throughout the target audience. By targeting subsets of communities, the TAI will reach a small further subset of people that are referred to herein as Mavens and Connectors.

Another aspect of the invention is that it allows for the acceleration of information throughout the TAI community via word of mouth marketing, also known as viral marketing. Viral marketing is extremely useful in the spread of any information throughout a society. The TAI, by virtue of its complete coverage within a market segment of common consumers (i.e., consumers with common goals, interests and/or purpose), will inevitably reach the “Market Mavens” within any target group. Market Mavens like to share and spread their knowledge of products and services throughout society. Market Mavens are trusted sources of information, further creating a “referred” source of information, deepening the value of the information pertaining to the TAI location. Consumers will always search out these Mavens when they are looking to procure a product or service.

Yet another feature of the invention allows for the acceleration of information via contact with Connectors. Connectors are people in society that know an exponentially larger number of people than the average person, and in turn they “connect” these large groups of people to one another. Connectors are useful in the spread of information via their connecting people, and specifically Mavens, with other groups of people. In some cases Connectors and Mavens are one in the same.

Another aspect of the current invention utilizes genealogically local purveyors of the TAI. These local purveyors become TAI Entities, and then receive co-branded promotional materials that become distributed throughout their subset of people. This allows for the quickest and deepest penetration of information throughout a subset. The local nature of a TAI Entity (i.e., where a TAI Entity's connection to the targeted traffic is of local genealogy to their cause), can further “initiate” traffic to the location.

Still another aspect of the current invention utilizes the benefit of a “referral” to drive a subset to the TAI location. Referrals increase the chances a person will take the desired action and login to view the TAI location and support their referring TAI Entity.

Another feature of the current invention utilizes a viral circle of a subset of a social group by creating a self serving and supporting viral economic benefit for the TAI Entity. This insures the life cycle of the TAI is ongoing. As the TAI ages, its sphere of coverage and influence widens in direct proportion to its age, until it reaches critical mass by garnering near 100% coverage of the targeted group. By targeting many subsets of society, the TAI can cover a majority of societal groups, and in turn society itself.

A further feature is that the use of customized marketing collateral, positioned to help a charitable organization, a local non-profit, or an individual gain a personal traffic flow to the location, is accomplished on a grand scale with regards to the volume of traffic that can be enjoined. This collateral is indexed by group and\or individual for tracking and calculation of reward benefit.

Furthermore, a TAI can be a long-term generator of traffic due to a possible non-terminated partnership between the Initiator 10 and the TAI Entities 12 that continues to grow as the targeted location supports greater depth and breadth of presence. As the support beneficiary population grows within the location, the amount of the “fund” grows based on a predetermined percent of the donor fund contributed, supporting a larger number of TAI Entities, and creating an ongoing, continually enlarging, cyclical, symbiotic, self supporting relationship.

In additional, a TAI can be used in conjunction with an engineered web portal, such as that described in co-pending U.S. patent application No. [32188US01], which is incorporated herein by reference, to initiate, accelerate, penetrate and increase viewership within a targeted online area prior to the point of traditional online browser mount points to the Internet. Control of this viewership is significant to marketing campaigns and is the subject of the elusive unique visitor hits as well as repeat visitors garnered highly by all of the major Internet search engines, online yellow pages, and all Internet marketing organizations.

While specific embodiments of the present invention have been described, it should be noted that various modifications thereto can be made without departing from the spirit and scope of the invention as defined in the appended claims.

What is claimed is:

1. A method of pushing a targeted audience to a specific location, said method comprising:
identifying an entity having a connection to said targeted audience;
agreeing to enter into a Targeted Audience Initiator arrangement with said entity;
providing said entity with means for pushing members of said targeted audience to said specific location; and
compensating said entity for pushing members of said targeted audience to said specific location.

2. The method of claim 1 wherein agreeing to enter into a Targeted Audience Initiator arrangement with said entity includes agreeing to how said entity will be compensated for pushing members of said targeted audience to said specific location.

3. The method of claim 1 wherein said means for pushing comprises promotional materials that include information on how to access said specific location.

4. The method of claim 3 wherein said promotional materials include an ID number assigned to said entity.

5. The method of claim 3 wherein said promotional materials are co-branded to identify said entity and an initiating party.

6. The method of claim 1 wherein said specific location is a web site.

7. The method of claim 6 further comprising providing a dynamic web form that allows members of said targeted audience to submit information about themselves.

8. The method of claim 6 further comprising allowing members of said targeted audience to request information.

9. The method of claim 1 wherein said entity is compensated with an upfront prize or current cash value.

10. The method of claim 1 wherein said entity is compensated with a predetermined amount per each targeted audience member visit to said specific location.

11. The method of claim 1 wherein said entity is compensated with a percentage of a total compensation pool based upon the number of targeted audience member visits to said specific location attributable to said entity.

12. The method of claim 1 wherein said entity is an educational institution.

13. The method of claim 1 wherein said entity is a non-profit organization.

14. The method of claim 1 wherein said entity is a home-based business.

15. The method of claim 1 wherein said entity is a special interest group.
